(19) United States
(12) Patent Application Publication
(10) Pub. No.: US 2002/0171697 A1
(43) Pub. Date: Nov. 21, 2002

(54) Method and system for compensating for banding defects in inkjet printers

(76) Inventors: Eyal Gargir, Kfar Saba (IL); Limor Tirosh, Tel Aviv (IL); Lior Lifshitz, Maoz Zion (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 10/115,567

(22) Filed: Apr. 4, 2002

Related U.S. Application Data
(60) Provisional application No. 60/281,012, filed on Apr. 4, 2001.

(51) Int. Cl. B41J 29/38

(52) U.S. Cl. 347/14

(57) ABSTRACT

A method and system for compensating for banding defects il inkjet printer in provided. The mnetlod comprising identifyg one or more nozzles whose coatribution to a printed test image is witliin a defned range around a banding defect appearing in He printed test image and generating compensation data for at least one of the identified nozzles.

### CROSS REFERENCE TO RELATED APPLICATIONS

The present application claims priority from U.S. provisional application Serial No, 60/281,012, filed Apr. 4, 2001.

### BACKGROUND OF THE INVENTION

During printing, inkjet printers tend to produce various defects, which are readily distinguishable by the human eye. These defects, which are known in the art as banding defects, may appear as bands of various shades, as stripes, or as isolated lines, Banding is commonly caused by misfiring nozzles or by errors in the direction that the ink droplets talce when they leave the nozzles. Banding defects are generally oriented parallel to the direction of inovenient of the print head.

It is custonary to reduce the banding by overprinting the substrate several times using a multi-pass print mode. This method however cannot reduce dark banding defects. Aaiother existing method for correcting banding defects involves firstly te identification of the misfiring nozzles and secondly using functioning nozzles to print the data of tlhe misfiring nozzles, Since nozzles may operate within a range of tolerance, the identification of the malfimctioning nozzles and their problems may be an inaccurate and complicated task.

### BRIEF DlESCPTION OF THE DRAWINGS

The subject matter regarded as the invention is particularly pointed out and distinctly claimed in the concluding portion of the specification. The invention, hbwever, both as to organization and method of operation, together with objects, features, and advantages thereof, may best be understood by reference to the following detailed description when read with the accompanying drawings, in which:

FIG. 1 is a flow chart diagram illustrating a banding defect compensation method according to some embodiments of the present invention;

FIG. 2 is a block diagram illustration of an inkiet printing system havng a banding compensation module according to some embodiments of the present invention;

FIGS. 3A -3D axe schematic illustrations of an exemplary printout of a banding identification test image (BITl) data file according to some embodiments of the present invention;

FIG. 4 is a schematic illustation of the compensation method of light banding defects according to some embodiments of the present invention; and

FIG. 5 is a schematic illustration of a portion of an exemplay printout of a banding identification test image (BITI) data file for a two-pass print mode according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Furtlher, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those of ordinary skill in the art that the present invention may be practiced without these specific details. In other insaces, well-known methods, procedures, and components have not been described in detail so as not to obscure the present invention

Some embodiments of the present invention are directed to compensating banding defects in inkjet printing without establishing a direct correlation between a banding defect and one or more nozzles that may have created the banding defect. Inl the description below, the example of an iilcjet application is given, however these embodiments are equally applicable to other printing systems, such as, for example, thermal transfer painting. The compensation method may be used for a single print head or a multi-segnment print head performing in a single pass or a multi-pass print mode.

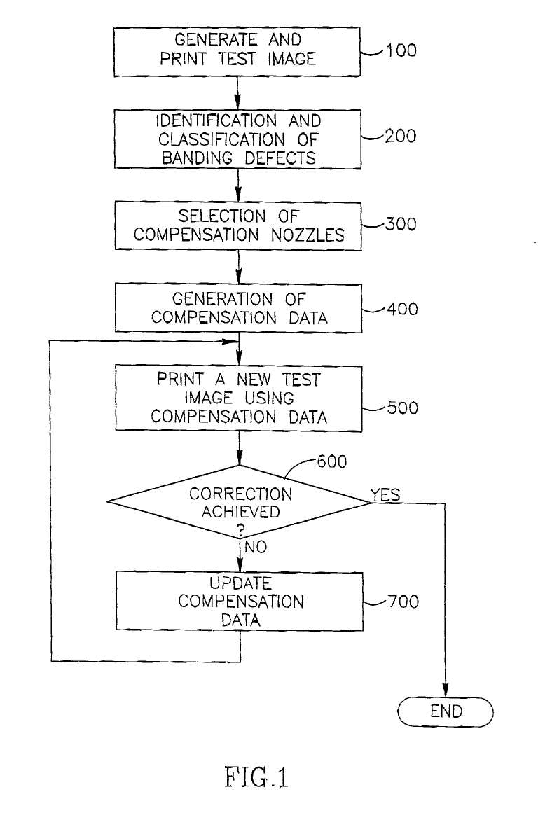

Reference is now made to FIG. 1, which is a flow chart diagram illustrating a banding defect compensation method according to some embodiments of the present invention. It should be noted that operations associated with the compensation method may be executed in either an on-line mode, an off-line mode or any combination thereof According to some embodiments of the preseint invention, the method involves idenitifling one or more compensating nozzles for a band without identiliig the malfinctioning nozzles themselves.

Initially, a banding identification test image (BITI) data file may be generated and printed (block 100). In a multi-color printing system, it may be desirable to print each color separation individually. The BITI may be designed according to the print head assembly structure and may be related to the arrangement and number of nozzles, the number of print head segmcnts, and the number of passes.

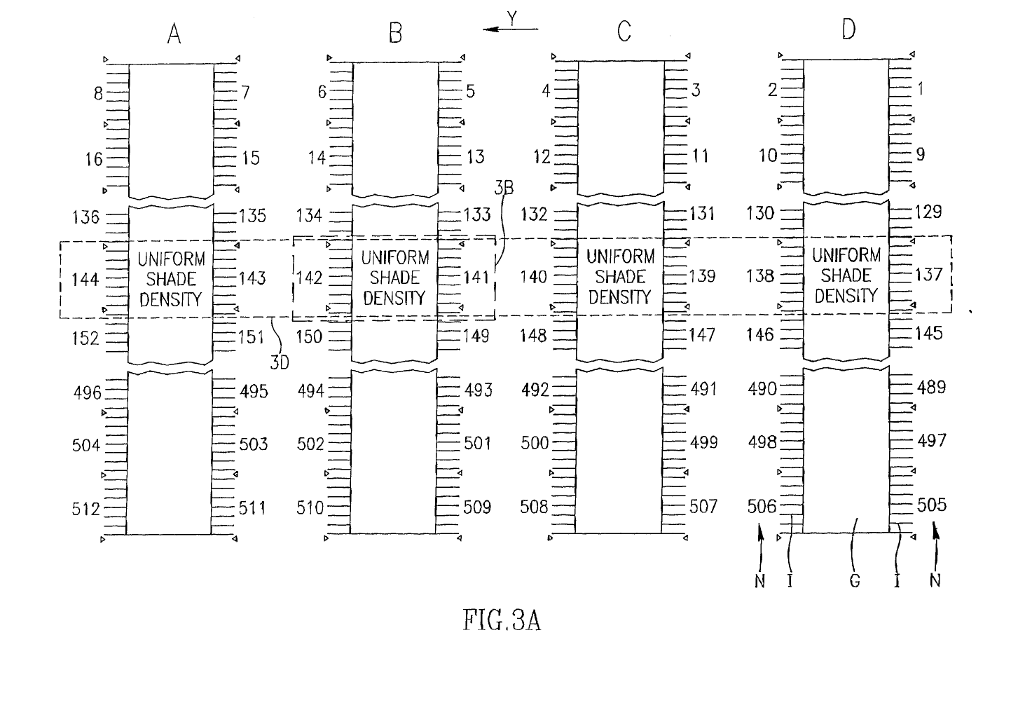

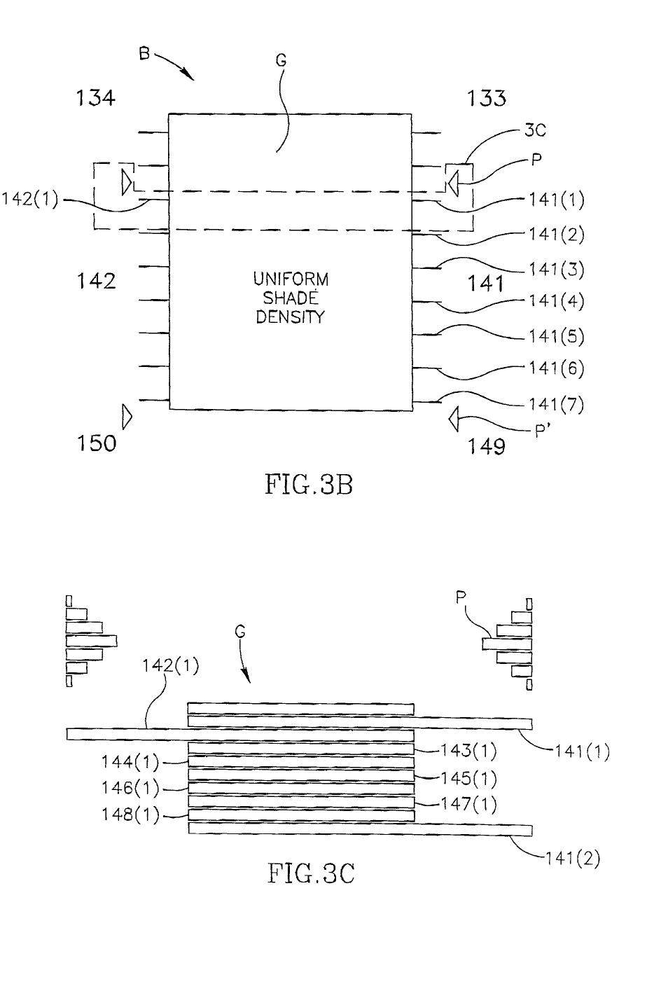

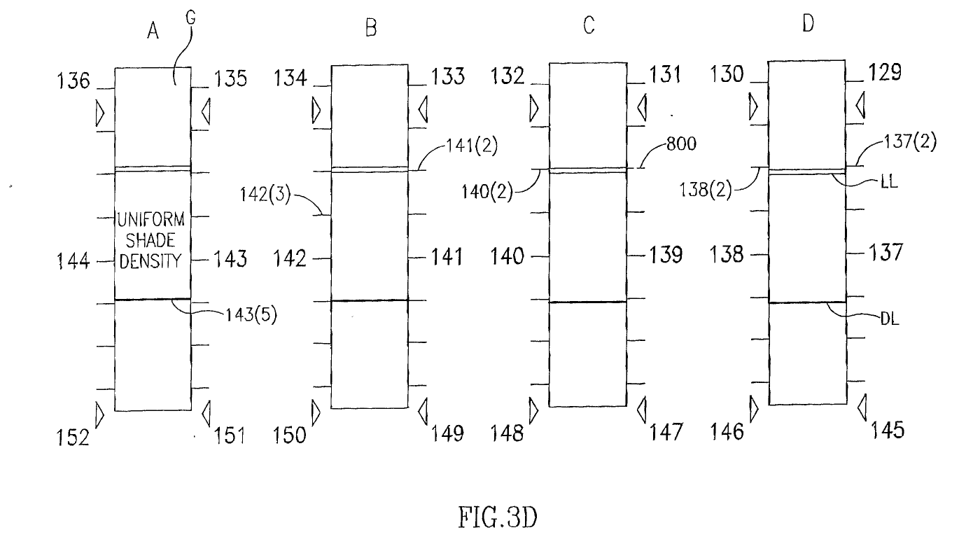

Generally, die BITI comprises several columns, each column haviig a central portion and side portions. The central portion is a uniform pattern having a uniform shade density, such as, for example, a 33% dot percent and the side portions comprising hidex lines, each line representing a particular nozzle. An exemplary BITI is described hereinbelow in relation to FIGS. 3A-3D.

Next, an operator or a machine may visally identify and classify banding defects printed on a printout of the BITI (block 200). Alternatively, the printout of the BITI may be scanned by a scanner and the scanned Bm may be used to identify the banding defects and to generate compensation data using an image processing application, A banding defect may be classified as a light band or a dark band. A light banding defect is characterized by a print density, which is lower than the print density in its vicimity. A dark banding defect is characterized by a print density, which is higer than the print density in its vicinity.

Based on the identification nid classication of the banding defects, one or more compensating nozzles may be selected (block 300). The selected nozzles are not necessarily those that lhave created the defect. A compensation rile having data associated with the selected compensation nozzles and the compensation process may be generated (block 400). The compensation file may comprise identification numbers (ID) of the selected compensating nozzles and compensation factors related to the selected nozzles.

A compensation factor mtay be related to the number of ink droplets, the volume of ink droplets, or a combination thereof. The BITI data file may then be modified. Alternatively, control signals associated ith the image may be modified. The image may then be printed using the modified BITI file or the modified control signals associated with the BITI file (block 500).

A dark band may be compensated for by selecting one or more nozzles, for example, a nozzle that passes over the dark band and reducing the density of data printed by the selected nozzles by reducing the compensation factor, which may be related to the number of Ink droplets or to the voluine of ink within the droplets of the selected nozzle. A light band may be compensated for by selectilg one or more nozzles, for example, nozzles that pass over the borderlines of the light band and by increasing the density of data printed by the selected nozzles by increasing the compensation factor of the selected nozzles. For certain banding defects, a combination of an increase in print density for some nozzles and a decrease in print density for other nozzles may be most suitable.

The new printout may be inspected for the presence of banding defects (lock 600). If identified banding defects are within tolerable levels the process is terminated. The compensation data of the compensation file may then be used to modify original ie data or control signals related to printing the image data such that to prevent visible banding defect on the printed image.

If the banding defects are still visible, the process may be repeated again. Different parameters may be taken (block 700) and an updated compensation file may be generated. If after a predefined number of cycles, identified banding defects are not within tolerable levels, the process may be terminated.

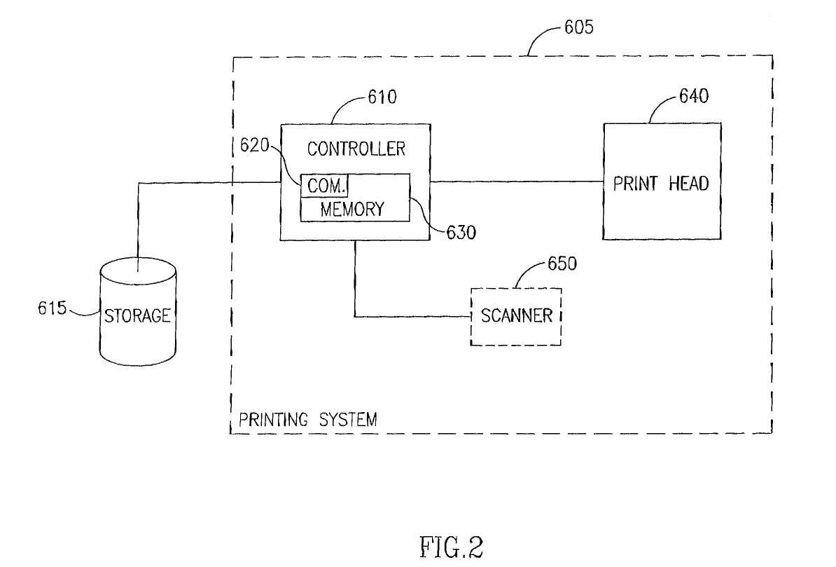

Reference is now made to FIG. 2, which is a block diagram of an inkjet printing system having a banding compensation module performing the methods described above according to some embodiments of the present invention. A printing system 605 may comprise a controller 610, which may extract original image data stored in a storage device 615, such as, for example, a bard disc. A compensation data file 620, prepared ahead of time or on-line according to the methods described hereinabove may be loaded into a memory 630 of controller 610.

System 605 may optionally comprise a scanner 650 coupled to controller 610. A BITI printed by an incjet print head 640 may be scanned by scanner 650 and the scanned BITI may be used to identify the banding defects and to generate compensation data vsing an image processing application. The original image data file may be modified using the data stored in the compensation data file by increasing the ink droplet volume of selected nozzles. Alternatively, controller 610 may modify the control signals regarding the number of droplets to be fired from the selected nozzles. The modified image data file and/or modified control signals may be delivered to print head 640 for printing.

Reference is now made to FIGS. 3A-3D, which are schematic illustrations of an exemplar printout of a single-pass BITI data file according to some embodiments of the present invention. It should be understood to those skilled in the art that a suitable BITI data file may be designed for a single prnthead or a multi-segmental print head comprising any number of nozzles arranged in various geometrical arrangements. Therefore, it is noted that the specific BITI discussed below is by way of example only and does not limit the scope of tle invention. The exemplary BITI may be used for a print head assembly of seven print heads. Each print head may comprise a bi-dimensional array of 512 nozzles arranged in 64 columns and 8 rows.

FIG. 3A illustrates a fill printout having four columns A-D, each perpendicular to the direction of movement of the print head assembly as shown by arrow Y. Each column has a central portion G, which may be, for example, a uniform pattern such as a 33% dot percent Areas G represent an average image area that enables inspection of banding defects. Each column may fater comprise index areas I on both sides of central portion G. Each index area I may comprise index lines, each index line is printed by one of the 3584 nozzles of the print head assembly.

Each coluiin may farther comprise two ID areas N each adjacent to one of index areas I. Each ID area N comprises ID nunbers of nozzles such that each ID number is positioned in the vicinity of index lines produced by nozzles from all print head segments having the same ID number. Every seven index-ines, a pointer P is printed to indicate the area of printed index lines that are jetted from nozes having the same ID number.

For example, the first top seven index lines of the right index area I of column D are each jetted from a nozzle having an ID no. 1, each nozzle belonging to a different one of the seven print head segments. The folloiig seven index lines are each jetted from a nozzle having an ID no. 9, each nozzle belonging to a different one of the seven print head seginents. As can be seen, index lines jetted by adjacent nozzles are printed in non-adjacent positions to enable identification of nozzles, as will be described in detail with respect to FIG. 2B.

FIG. 3B is an enlarged illustration of a portion of column B of FIG. 3A illustrating in greater detail the technique of identification of correction nozzles according to some embodiments of the present invention. An index line 141(1^{St}) positioned below pointer P is generated by a nozzle having an ID no. 141 that belongs to the first print head segment of the print head assembly. An index line 141 (2^{nd}) positioned below index line 141 (1^{st}) is generated by a nozzle having an ID no. 141 that belongs to thie second print head segment. An index line 141 (7^{th}) positioned above a pointer P’ is generated by a nozzle having ID no. 141 that belongs to the seventh print head segment. The index line (not shown) below pointer P’ is generated by a nozzle having an ID no. 149 that belongs to the first print head segment.

FIG. 3C is an enlarged illustration of the area between index line 141 (lst) and ₁₄₁(2^{nd}) of FIG. 3A. In this enlargement, glay area G is illustrated by parallel lines, each generated by a particular nozzle as shown.

Reference is now shown to FIG. 3D, which is an enlargement of a portion of the BITI of FIG. 3A having two exemplary banding defects. The exemplary BITI comprise a light band LL and a dark band DL. Area G of each column exhibits the same pattern and therefore, the banding defects are reproduced in area G of each column.

Light banding defect inspection—The instrumental or human visual inspection of the BITI illustrated in FIG. 3D may identify index line 138 (2^{nd}) of column D and index line 140 (2^{nd}) of column C as positioned adjacent to light band LL. Therefore, nozzle 138 tt belongs to second print head segment and/or nozzle 140 of second print head seginent may be used as compensating nozzles to compensate for banding defect LL by increasing their compensation factor. As can be seen, the generation of banding defect LL may have been caused by a misfiring nozzle 139 (2^{nd}), which should have produce an index line at position 800. The compensating nozzles identified above are the closest neighboring nozzles on both sides of the nozzle that should have produced the index line at position 800, It should be noted, however. that it is not necessary to identify the nozzle or nozzles causing the banding defect.

Occasionaly, supplementary compensating nozzles may be required to correct the banding defect LL. As can be seen in FIG. 3D, index line 137 (2^{nd}) of column D and index line 141 (2^{nd}) of column B are also positioned adjacent to light band LL, Therefore, nozzle 137 of the second print head seginent and/or nozzle 141 of tie second print head segment may be used as additional compensating nozzles to correct banding defect LL by increasing their compensation factor.

Dark banding defect inspection—The instumental or human visual inspection of toe BITI illustrated in FIG. 2D may identify index line 143 (5^{th}) of column A as closest to dark band DL. Therefore, nozzle 143 of the fifth print head segment may be used as a compensating nozzle to correct banding defect DL by decreasing its compensation factor.

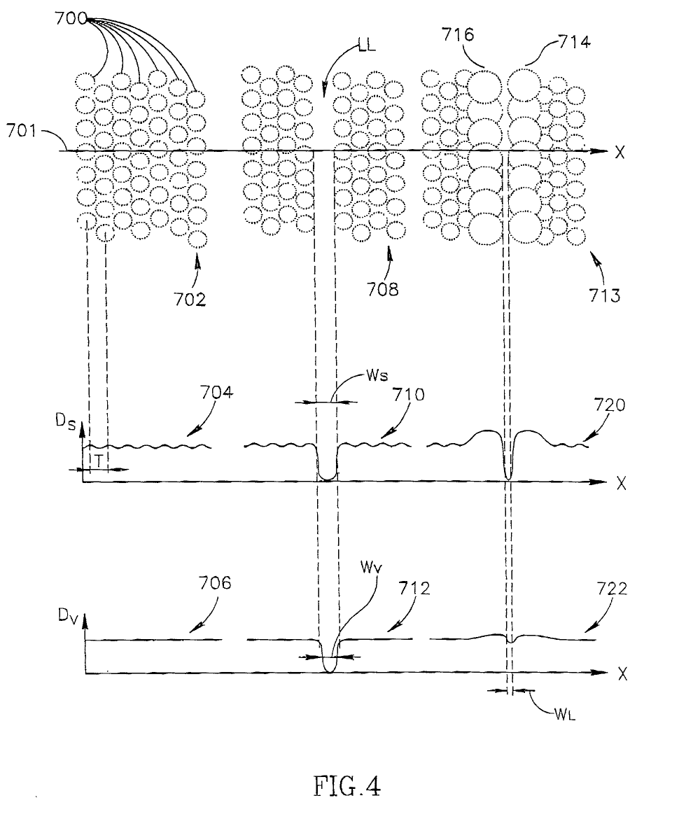

Reference is now made to FIG. 4, which is a schematic illustration of the compensation method of light banding defects as described above according to some embodiments of tle present invention. For ease of explanation, the following discussion refers to an exemplary white opaque substrate. Usually, an area with a visually uniform ink density is created by an array of ink droplets, such as, for example, aray 702 having multiple ink droplets 700.

It is noted here that commonly the inlc droplets are jetted in an overlapping manner, however, for simplicity, the droplets are drawn apart. Graph 704 represents a local density of the printed area along line 701 as measured by a meaurement device, such as, for example, a suitable densitometer. The period T between two maximum points of graph 704 is approximately equal to the distance between the centers of two droplets of adjacent printed lines. Graph 706 represents the visual density, namely, actual perception by the eye of line 701. The naked human eye is unable to see individual droplets but rather perceive them as a line 706 having an even average density

Array 708 represents a portion of a printed substrate having light banding defect LL. Graph 710 represents a local density of the printed area along line 701 as measured by a measurement device. The minimum of graph 710 represents the decrease of the density in the area of line LL. The width Ws of graph 710 is generally equal to the width of line LL. Graph 712 represent the visual density of light banding defect LL as detected by the niaked human eye. The visual width Wv of graph 712 is smaller than the geometrical width as detected by the densitometer. Even though, the naked eye cannot detect lack of a single drop, it is able to detect the defect because it appears as continuous band different from its envirornent.

Array 713 illustrates a compensating method according to some embodiments of the present invention. The principles of compensating method are based on the physiological behavior of the unaided eye. For a light band defect, it is desirable to add infonation that the eye may not be able to isolate and therefore may not detect the defect By changing the local print density in the vicinity of the defect, the eye may not detect the light defect.

Light banding defect LL may be compensated for by increasing the compensation factor associated with nozzles that aim to the neighboring lines of line LL and therefore increasing the print density of lines 714 and 716. Referring back to FIG. 3D, nozzle 138 (2^{nd}) and ₁₄₀(2^{nd}) increase the print density of lines 714 and 716, neighbors of line LL. A densitometer graph 720 amd the visual density graph 722 illustrate the compensation results. As can be seen from graph 722, the naked eye may not perceive the light defect when the width of line LL is diminished to a smaller value of W_{L}.

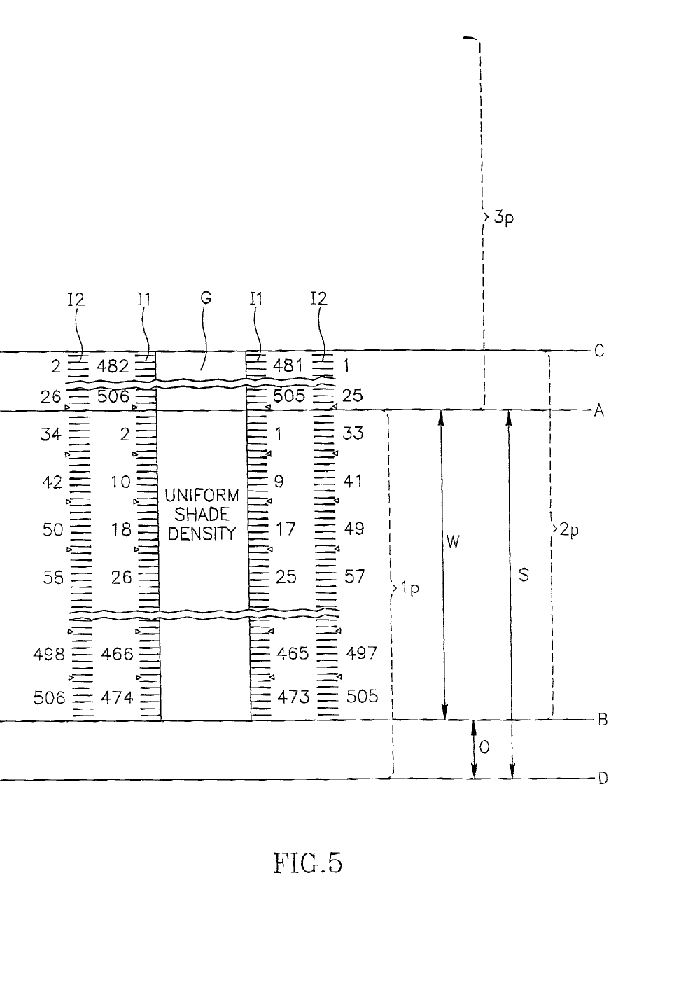

Reference is now made to FIG. 5, which is a schematic illustration of a column of an exemplary printout of a banding identification test image (BITI) data file for a twopass print inode according to some embodiments of the present invention. In a two-pass print mode, two different nozzles pass each point on a substrate. S indicates the print head width and 0 indicates the step distance. The print head position is moved by a distance W. which equals to the difference between S and 0.

A BITI printout for a two-pass print node is described for simplicity, however, it should be understood by a person skilled in the art that BITI files for higher multi-pass print modes may be designed using similar principles.

Each column of a two-pass BITI may comprise a central gray area G, two first index lines areas I₁ from both sides of area G and two second index lines areas I₂ , each adjacent to a corresponding first index line area I₁. First index lines I₁ between horizontal lines B and A are printed in a first pass 1P and first index lines I₁between horizontal lines A and C are printed in a third pass 3P, which has the same direction of the first pass. Second index lines I₂ between horizontal lines B and C are printed in a second pass 2P. In general, for each additional pass, additional index line areas are printed to enable identification of nozzles in the vicinity of banding defects.

After a second pass indicated by 2P, each horizontal row of area G between horizontal lines A and B is printed by two different nozzles- For example, a certain row may be printed by a nozzle having ID no. 1 in the first pass and by a nozzle having ID no. 33 in the second pass. Each row of area G, between horizontal lines C and A is printed by two different nozzles after the third pass, which is a second first pass.

While certain features of the invention have been illustrated and described herein, many modifications, substitutions, changes, and equivalents will now occur to those of ordinary sldll in the art. It is, therefore, to be understood that the appended claims are intended to cover all such modifications and changes as fall witin the true spirit of the invention.

What is claimed is:

1. A method comprising:
identifying one or more nozzles whose contribution to a printed test image is witin a defined range around a banding defect appearing in said printed test image; and
generating compensation data for selected one or more of said identified nozzles.

2. The method of claim 1, wherein said banding defect is a light band and said compensation data represents an increase of volunie of ink droplets for said one or more selected nozzles.

3. The method of claim 1, wlherein said banding defect is a light band and said compensation data represents an increase of number of ink droplets for said one or more selected nozzles.

4. The method of claim 1, wherein said banding defect is a dark band mid sad compensation data represents a decrease of volume of ink droplets for said one or more selected nozzles.

5. The method. of claim 1, wherein said banding defect is a dark band and said coinpensation data represents a decrease of number of ink droplets for said one or more selected nozzles.

6. The method of claim 1 further comprising:
moditying image data using said compensation data.

7, The method of claim 1 furher comprising:
modifying control signals associated said selected nozzles using said compensation data when printing an image.

8. An inlcjet printing system comprising:
one or more print heads; and
a controller able to identify one or more nozzles whose contribution to a printed test image is within a defined range around a banding defect appearing in said printed test image and to generate comnpensation data for selected ones of said identified nozzles.

9. The system of claim 9, further comprising a scajnier to scan said printed test image.
